(19) United States
(12) Patent Application Publication
(10) Pub. No.: US 2003/0180201 A1
(43) Pub. Date: Sep. 25, 2003

(54) Heat transfer enhancing inserts for tubular catalyst bed reactors

(75) Inventors: Barbara A. Belt, Seabrook, TX (US); Stephen R. Landis, Katy, TX (US); Michael L. Casteel, Houston, TX (US); M. Andrew Crews, Bullard, TX (US); Kevin Maloney, Tyler, TX (US); Karl Hoitsma, Tyler, TX (US)

Correspondence Address: DAVID W. WESTPHAL, CONOCOPHILLIPS COMPNAY, P.O. BOX 1267, PONCA CITY, OK, 74602-1267, US

(73) Assignee: ConocoPhillips Company, Houston, TX (US)

(21) Appl. No.: 10/389,187

(22) Filed: Mar. 14, 2003

Related U.S. Application Data
(60) Provisional application No. 60/364,195, filed on Mar. 14, 2002.

(51) Int. Cl. B01J 8/04

(52) U.S. Cl. 422/196; 422/197; 422/198; 422/200; 422/211

(57) ABSTRACT

A tubular reactor with a catalyst bed and inserts placed within the tubes redirecting the flow from the center to the wall of the tube. The redirected flow increases the amount of heat transfer through the system by moving the reactants from the low heat transfer zone at the center of the tube to the high heat transfer zone at the wall of the tube. In one embodiment, the tubular reactor comprises a tubular reactor having a series of tubes, within the tubes are a plurality of flow obstructing inserts and a catalyst bed. The inserts may comprise a plurality of inclined, conical, or spiral plates. The plates may be affixed to the wall of the tube and may depend on the catalyst bed for structural support.

### CROSS-REFERENCE TO RELATED APPLICATIONS

The present application claims the benefit of 35 U.S.C. 111(b) Provisional Application Serial No. 60/364,195 filed Mar. 14, 2002, and entitled “Heat Transfer Enhancing Inserts for Tubular Catalyst Bed Reactors”.

### STATEMENT REGARDING FEDERALLY SPONSORED RESEARCH OR DEVELOPMENT

Not applicable.

### BACKGROUND OF THE INVENTION

The present invention relates generally to catalytic reactors, more specifically to tubular catalyst bed reactors. Still more specifically, the present invention relates to apparatus for increasing the heat transfer in a tubular catalyst bed reactor in order to increase the efficiency of the catalytic reaction.

Catalytic reactions are widely used to convert hydrocarbons, and other products, from one form into another. These reactions vary widely depending on the catalyst being utilized but one constraint that is common to most of these catalytic reactions is that the reactions are very dependent on temperature. Many catalytic reactions will only operate efficiently in a narrow range of temperatures. Sometimes these types of catalytic reactions are either highly exothermic or highly endothermic. Therefore, the ability to transfer heat to, or from, the reaction zone, in order to maintain the temperature of the reaction, is critical to the efficiency of the process. Thus these types of reactions can be referred to as heat transfer dependent reactions.

One such heat transfer dependent reaction is the Fischer-Tropsch reaction. In a Fischer-Tropsch reaction a gaseous mixture of hydrogen and carbon monoxide is exposed to a catalyst at an elevated temperature, normally between 400° and 450° F. The reactants combine to form gas and liquid hydrocarbons as well as some other by-products. The Fischer-Tropsch reaction is highly exothermic and temperature dependent and therefore will only produce the desired hydrocarbons in a narrow temperature range. Consequently, in a Fischer-Tropsch reactor, a lot of heat has to be removed from the reaction zone in order to keep the reaction temperature within the desirable range. Currently, two types of reactors are commonly used for low temperature Fischer-Tropsch reactions.

One such reactor is a slurry bubble column reactor. In slurry bubble column reactors, the catalyst is suspended in a liquid wax slurry and the reactant gases are bubbled through the slurry. Heat exchanger tubes are submerged within the reactor. A heat transfer fluid is circulated through the tubes to remove heat from the slurry. A common heat transfer fluid is steam generated from boiler feed water. The movement of the slurry and gas bubbles creates high-turbulence flow that helps to maintain high levels of heat transfer. Disadvantages of the slurry bubble column reactor mainly stem from the slurry mixture that can be erosive, separation of the catalyst from wax products, and a slurry mixture that may be hard to keep mixed properly. Some of these disadvantages can be alleviated by placing the catalyst in a stationary bed, such as in a tubular catalyst bed reactor.

In a tubular catalyst bed reactor, the catalyst is packed into the tubes of a heat exchanger, through which the reactants are passed. The tube is surrounded by a heat exchange fluid, which removes heat from the tubular reactors. One example is a Fischer-Tropsch tubular catalyst bed reactor, where steam created from boiler feed water is circulated, at a temperature lower than the reaction temperature, in order to drive the heat transfer across the reactor tubes so as to maintain the reactor at the desired reaction temperature. One of the drawbacks of some of the current tubular catalyst bed reactors is that, with highly exothermic, or endothermic, reactions, the heat transfer across the walls of a given tube is much greater than the heat transfer within the tube. This causes the temperature at the center of each tube to be much different than the temperature at the wall of the tube, making it difficult to maintain all areas of the reactor tube within the desired temperature limits for the reaction. This effect can be minimized by reducing the diameter of the tubes. Having smaller diameter tubes also increases the number of tubes required for a certain volume of reactants, thereby increasing the overall complexity and cost of the equipment. A fixed-bed catalyst system, or other type of catalyst bed system, used in tubular reactors has certain advantages over slurry bubble catalyst systems, but these advantages are currently limited by the disadvantageous heat transfer characteristics of prior art tubular catalyst bed reactors.

Thus, there remains a need in the art for methods and apparatus to improve the heat transfer performance of tubular catalyst bed reactors. Therefore, the present invention is directed to methods and apparatus for increasing the amount of heat transfer in a tubular catalyst bed reactor that seek to overcome these and other limitations of the prior art.

### SUMMARY OF THE PREFERRED EMBODIMENTS

Accordingly, there is provided herein tubular catalyst bed reactors having flow obstructing inserts placed within the tubes redirecting the flow from the center to the wall of the tube. The redirected flow increases the amount of heat transfer through the system by moving the reactants from center of the tube to the wall of the tube, thereby increasing the radial dispersion of the reactants and products.

In preferred embodiments, the invention includes at least the following embodiments. First, the tubular catalyst bed reactor comprises a reactor having a series of tubes through which reactants flow. Each tube has a catalyst bed and a plurality of inserts disposed within. The inserts are preferably intermittently placed along the length of the tube to redirect the flow from the inside of the tube toward the wall of the tube. The catalyst bed may be a fixed, ebulating, fluffed bed, or any type of catalyst bed where the catalyst particles are supported in one location and exposed to a flow of reactants.

The inserts may comprise a plurality of inclined plates disposed on a central shaft. The plates are inclined at an angle to the vertical with each plate being out of phase with the plates immediately adjacent. Alternatively, the plates may be conical plates disposed on the central shaft. The plates are preferably sized so as not to restrict the flow along the wall of the tube. The plates are constructed from a non-insulating, corrosion resistant material. The shaft and plate assembly are preferably removable from the tube but may also be permanent.

Alternatively, the tube insert may comprise one or more continuous spiral plates. The plates may be affixed to the wall of the tube and may depend on the catalyst bed for structural support.

The invention also is embodied as a method for increasing the heat transfer in a tubular catalyst bed reactor by disposing a plurality of inserts within the catalyst bed so as to redirect the flow of reactants from an inner portion of the tubular reactor to an outer portion of the tubular reactor. This redirection of flow increases the radial dispersion of the reactants and products.

Thus, the present invention comprises a combination of features and advantages that enable it to substantially increase heat transfer in a tubular catalyst bed reactor by providing apparatus that redirect the flow from areas of low heat transfer to areas of high heat transfer. These and various other characteristics and advantages of the present invention will be readily apparent to those skilled in the art upon reading the following detailed description of the preferred embodiments of the invention and by referring to the accompanying drawings.

### BRIEF DESCRIPTION OF THE DRAWINGS

For a more detailed understanding of the preferred embodiments, reference is made to the accompanying Figures, wherein:

FIG. 1 is a sectional view of a prior art tubular catalyst bed reactor;

FIG. 2 is a sectional view of a prior art reactor tube;

FIG. 3 is a sectional view of a first embodiment of the present invention;

FIG. 4 is a sectional view of a second embodiment of the present invention; and

FIG. 5 is a sectional view of a third embodiment of the present invention;

FIG. 6 is a sectional view of a fourth embodiment of the present invention.

### DETAILED DESCRIPTION OF THE PREFERRED EMBODIMENTS

In the description that follows, like parts are marked throughout the specification and drawings with the same reference numerals, respectively. The drawing figures are not necessarily to scale. Certain features of the invention may be shown exaggerated in scale or in somewhat schematic form and some details of conventional elements may not be shown in the interest of clarity and conciseness.

The present invention relates to methods and apparatus for redirecting the flow of a reactant stream from areas of low heat transfer to areas of high heat transfer thereby increasing the overall heat transfer of a tubular catalyst bed reactor system. The present invention is susceptible to embodiments of different forms. For example, the embodiments of the present invention may find useful application fixed-bed catalytic reactors but also in other catalyst beds, such as ebulating beds or fluffed beds, in which the catalyst is held in place but not truly fixed. There are shown in the drawings, and herein will be described in detail, specific embodiments of the present invention with the understanding that the present disclosure is to be considered an exemplification of the principles of the invention, and is not intended to limit the invention to that illustrated and described herein.

In particular, various embodiments of the present invention provide a number of different constructions of flow obstructing or radial dispersion enhancing inserts for increasing the heat transfer in tubular reactors by increasing the radial dispersion of the reactants and products. Reference is made to a Fischer-Tropsch reactor as one example of such a reactor, but the use of the present invention is not limited to Fischer-Tropsch reactors and will provide enhanced heat transfer in both endothermic and exothermic tubular catalyst bed reactors. It is to be fully recognized that the different teachings of the embodiments discussed below may be employed separately or in any suitable combination to produce desired results.

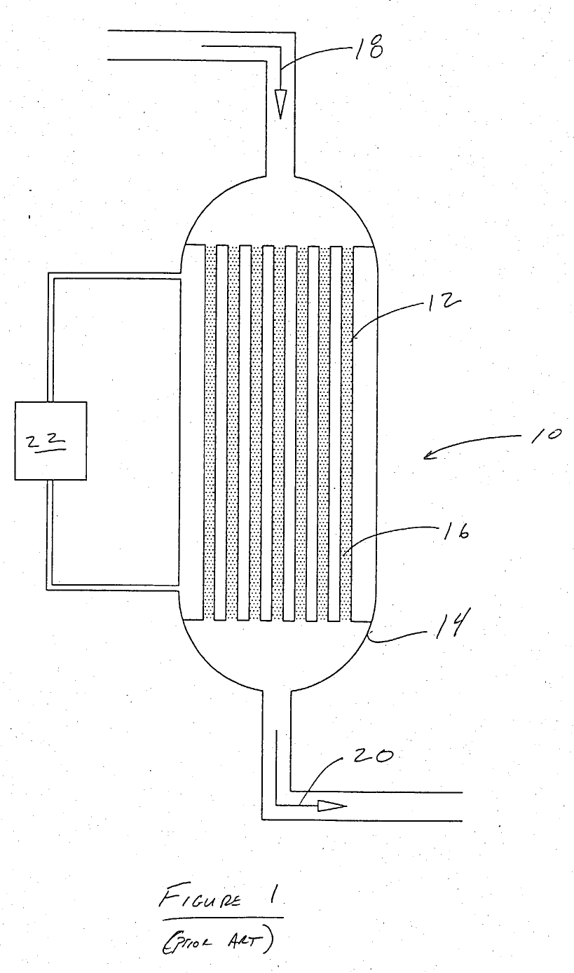

FIG. 1 shows a schematic representation of a conventional tubular catalyst bed reactor 10. Tubes 12 are installed within pressure vessel 14 and filled with a catalyst 16. Reactants 18 flow into tubes 12 and react on the catalyst 16 to form products 20. A heat transfer fluid system 22 circulates heat transfer fluid around the outside of the tubes 12 so as to add or remove heat from the tubes.

Now referring to FIG. 2, a section of a prior art reactor tube 12 is shown. Tube 12 is filled with a catalyst (not shown). The reactant fluids flowing through the tube are represented by arrows 24. Because the greatest amount of heat transfer occurs across the wall of the tube, the outer portion of the flow will have a greater amount of heat transfer with the tube wall and the heat transfer medium outside the tube.

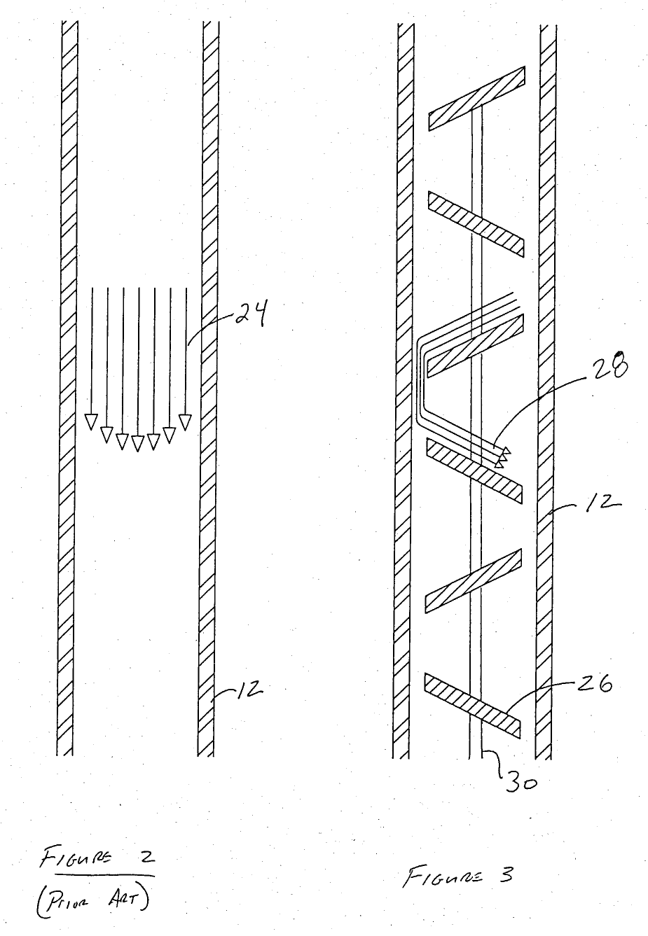

FIG. 3 shows one embodiment of the present invention, comprising a reactor tube 12 having inclined plates 26 placed in the flow path to manipulate the flow. The inclined plates 26 are preferably solid plates, supported on a center shaft 30, and are preferably configured to allow the passage of fluid between the outside edges of the plate and the inside wall of tube 12. Arrows 28 represent the path of the reactants as they flow through tube 12 and around inclined plates 26. As can be seen, inclined plates 26 redirect a portion of the flow, causing it to move alternately between the center and the edge of the tube. Inclined plates 26 are preferably arranged so that each plate is out of phase with either of its adjacent plates.

FIG. 4 shows a second embodiment comprising a reactor tube 12 having conical plates 32 disposed within the tube. Conical plates 32 are supported by a center shaft 34 and preferably sized so as to allow flow of fluids between the outer edge of the plate and the inside wall of the tube.

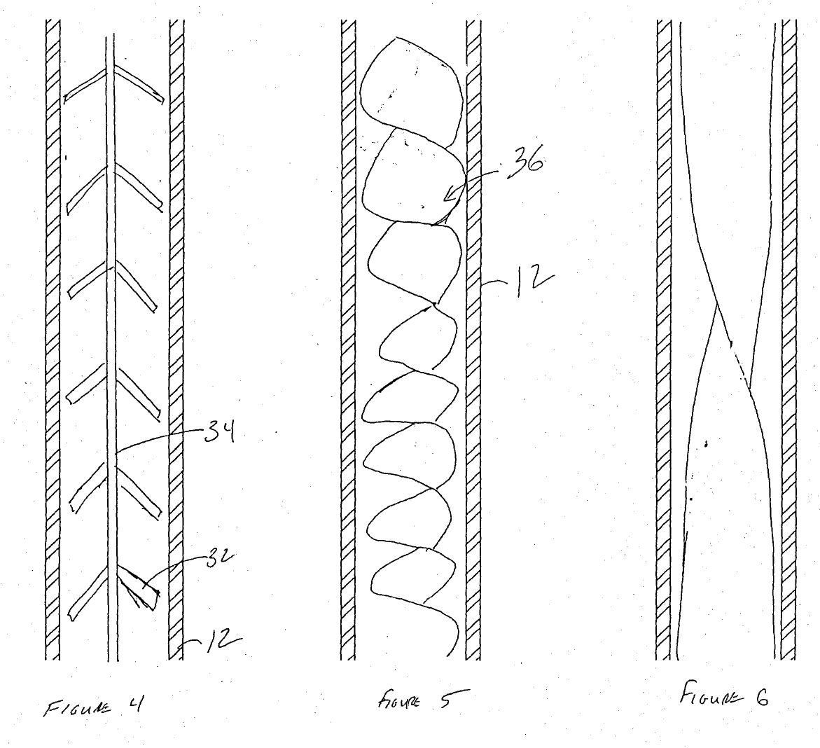

FIG. 5 shows a third embodiment comprising a reactor tube 12 having a spiral insert 36. Spiral insert 36 forces fluid from the center to the wall of tube 12 as the fluid moves down the tube. Another embodiment, as shown in FIG. 6, comprises a reactor tube 12 having a spiral insert 38 with fewer spiral rotations, and thus a smaller pitch, than the embodiment of FIG. 5.

All of the embodiments of the present tube inserts are designed to redirect at least a portion of the flow from the center of the reactor tube to the wall of the tube enhancing the radial dispersion of the reactants and products. Preferably, this redirection will occur continuously as the reactants flow through the tube. The inserts also serve to agitate the flow of fluid, thereby increasing the turbulence of the flow and further increasing heat transfer.

Another benefit of catalytic reactor tube inserts becomes apparent in gas-to-liquid (GTL) processes, where hydrocarbon gases are reacted to form liquid hydrocarbons. One such process is the Fischer-Tropsch reaction, where a mixture of hydrogen and carbon monoxide is reacted to form hydrocarbons. Because the reactants at the outer wall of the tube are being cooled, the newly formed hydrocarbons tend to condense and form liquids. The condensation of the hydrocarbons helps transfer heat from the center to the wall of the tube, further increasing the efficiency of the reactor.

It is preferred that the inserts be constructed of a thin, heat conductive material. It is preferred that the insert material be similar to the material from which the reactor tube is constructed, but it is important that the inserts not be subject to corrosion. The inserts may be attached to the reactor tube or free standing within the tube, the inserts may even rely on the catalyst for structural support.

The embodiments set forth herein are merely illustrative and do not limit the scope of the invention or the details therein. For example, any shape insert that will move the fluid flow between the center and the wall of the reactor tube may be used. Additionally, while reference was made specifically to a Fischer-Tropsch reactor, it is understood that the present invention will find utility in any heat transfer limited catalytic reaction. It will be appreciated that many other modifications and improvements to the disclosure herein may be made without departing from the scope of the invention or the inventive concepts herein disclosed. Because many varying and different embodiments may be made within the scope of the inventive concept herein taught, including equivalent structures or materials hereafter thought of, and because many modifications may be made in the embodiments herein detailed in accordance with the descriptive requirements of the law, it is to be understood that the details herein are to be interpreted as illustrative and not in a limiting sense.

What is claimed is:

1. A multi-tube heat exchange reactor, comprising:
a shell having a first inlet and a first outlet for a heat transfer medium and a second inlet and second outlet for a flow stream;
a plurality of heat exchange tubes, each tube comprising an interior region and a tube wall having an interior and exterior surface, said plurality of tubes being connected in fluid communication between said second inlet and second outlet, wherein said tubes are positioned within said shell so that the heat transfer medium contacts the exterior surface of the walls of said plurality of tubes;
a catalyst for supporting a chemical reaction disposed within each of said plurality of tubes; and
one or more inserts disposed within the catalyst bed of one or more of the plurality of heat exchange tubes, arranged so as to divert a portion of the flow stream between the interior region the tube and the interior surface of the wall of the tube.

2. The reactor of claim 1 wherein said inserts comprise a plurality of flat plates, positioned at intervals along the length of the heat exchange tube and at an angle to a center axis of the tube, wherein each plate is out of phase with the plates located adjacent thereto.

3. The reactor of claim 1 wherein said inserts comprise a plurality of conical plates positioned at intervals along the length of the heat exchange tube.

4. The reactor of claim 1 wherein said inserts comprise one or more continuous spiral plates.

5. A heat exchange tube for use in a catalytic reactor, comprising
a hollow, elongated, cylindrical body;
a chemical reaction supporting catalyst packed within said body, and
one or more inserts disposed within said catalyst, wherein the inserts redirect a portion of a flow moving through the tube towards and away from said body as the flow moves through the tube.

6. The heat exchange tube of claim 5 wherein said inserts comprise a plurality of flat plates, positioned at intervals along the length of the heat exchange tube and at an angle to a center axis of the tube, wherein each plate is out of phase with the plates located adjacent thereto.

7. The heat exchange tube of claim 5 wherein said inserts comprise a plurality of conical plates positioned at intervals along the length of the heat exchange tube.

8. The heat exchange tube of claim 5 wherein said inserts comprise one or more continuous spiral plates.

9. A method of increasing the heat transfer between a fluid undergoing a chemical reaction while flowing across a catalyst in a tube and the surface of the tube by providing one or more inserts within the tube so as to redirect a portion of the fluid toward the surface of the tube.

10. The method of claim 9 wherein said inserts comprise a plurality of flat plates, positioned at intervals along the length of the heat exchange tube and at an angle to a center axis of the tube, wherein each plate is out of phase with the plates located adjacent thereto.

11. The method of claim 9 wherein said inserts comprise a plurality of conical plates positioned at intervals along the length of the heat exchange tube.

12. The method of claim 9 wherein said inserts comprise one or more continuous spiral plates.
